(19) United States
(12) Patent Application Publication
(10) Pub. No.: US 2025/0233326 A9
(43) Pub. Date: Jul. 17, 2025

(54) CURRENT COLLECTOR AND KIT-OF-PARTS

(71) Applicant: FLEXFY GmbH, Rossdorf (DE)

(72) Inventors: Christian Walter, Reinheim (DE); Anja Schröpfer, Rossdorf (DE); Victor Franke, Darmstadt (DE); Ahmed Fakher, Langen (DE)

(21) Appl. No.: 18/573,875

(22) PCT Filed: Aug. 13, 2021
(86) PCT No.: PCT/EP2021/072629

§ 371 Date: Dec. 22, 2023

(51) Int. Cl. H01R 4/2406

(52) U.S. Cl. CPC H01R 4/2406

(57) ABSTRACT

A current collector for an electrical load for attachment to a carrier system with a large number of longitudinal electrical conductor tracks which run parallel to one another and have an alternating electric potential. The current collector comprises at least three, preferably at least five, and particularly preferably precisely five, electrically conductive contact elements with a cross-sectional width, in particular an operative diameter, wherein the contact elements form a polygon with a height, provision is made for the contact elements to have a contact element length, such as a needle length, for the conductor tracks to pass through.

### BACKGROUND

### Technical Field

The present disclosure relates to a current collector for an electrical load for mounting on a support system with a plurality of longitudinal electrical conductor paths running parallel to one another with alternating electrical potential. In some cases, the current collector implements a contacting adapter. The present disclosure also relates to a kit-of-parts which contains at least one current collector and a support system which is equipped with a plurality of longitudinal electrical surface conductor paths running in each case at a transverse distance from one another with a transverse width.

### Description of the Related Art

US 2009/0219712 A1 describes a lighting system with an electrically conductive wallpaper. The wallpaper can be mounted on a building wall or ceiling. A plurality of electrically conductive strips is provided on the wallpaper. Electrical lighting means can be connected to the conductive strips by contact pins. The strips and contact pins are provided at a specific distance from one another so that strips of different potential can be brought into contact with different contact pins. The use of the lighting system is susceptible to faults. When mounting a lighting means, the electrical connection required for the operation of the lighting means is often not closed. In the worst case, short circuits can occur.

Another lighting system with an electrode device and an electrical lighting means is known from US 2010/0327744 A1. The electrode device comprises two electrodes of different polarity, which engage one another in a comb-like manner, and a shield covering the electrodes. The electrode device can form a wall or ceiling facade with the shield. The lighting means has a base with a plurality of needle-shaped contact elements in order to penetrate through the shield to the electrodes. The contact elements are arranged in a triangular configuration. The shape and size of the electrodes and thus of the electrode device is fixed in an invariable manner. Individual made-to-measure products lead to very high costs and are therefore scarcely widespread. Even small damages to the electrode device often leads to short circuits of the two electrodes and thereby to a complete failure of the lighting system.

Thus, there is accordingly a need to overcome the disadvantages of the prior art, in some cases to provide a current collector which can be used simply, reliably, safely, in some other cases can be used independently of position and orientation on a flat support system with electrical conductor paths of different potential, wherein in some cases the current collector should be reversibly fastenable, in some other cases without aesthetic impairment of a support system.

### BRIEF SUMMARY

Accordingly, disclosed herein is a current collector, in some cases contacting adapter, for an electrical load for mounting on a support system with a plurality of longitudinal electrical conductor paths running parallel to one another and in each case at a transverse distance (t) from one another with a transverse width (b) with alternating electrical potential, comprising at least three, in some cases at least five and in some even other cases exactly five, electrically conductive contact elements with a cross-sectional width (p), in some cases an operative diameter, wherein the contact elements form a polygon with a height (H), wherein the contact elements have a contact element length (n), such as a needle length, for penetrating the conductor paths.

### BRIEF DESCRIPTION OF THE SEVERAL VIEWS OF THE DRAWINGS

Further properties, features and advantages of the present disclosure will become clear from the following description of an expedient embodiment of the present disclosure with reference to the attached drawing, in which:

FIG. 1 shows a schematic representation of an exemplary embodiment of a kit-of-parts according to the present disclosure;

FIG. 2 shows a schematic representation of an exemplary embodiment of a kit-of-parts according to the present disclosure with two different current collectors;

FIG. 3 shows a schematic representation of an exemplary embodiment of a kit-of-parts according to the present disclosure with a current collector;

FIG. 4 shows a schematic sectional view of an exemplary embodiment of a kit-of-parts according to the present disclosure with a functional object;

FIG. 5 shows a schematic representation of a current collector according to the present disclosure; and

FIG. 6 shows another view of the current collector according to FIG. 5.

### DETAILED DESCRIPTION

Furthermore, in some cases also disclosed herein is a current collector, in some other cases a contacting adapter, for an electrical load for mounting on a support system with a plurality of longitudinal electrical conductor paths running parallel to one another and in each case at a transverse distance (t) from one another with a transverse width (b) with alternating electrical potential, comprising at least three, in some cases at least five and in some other cases exactly five, electrically conductive contact elements with a cross-sectional width (p), in some cases an operative diameter, arranged and adapted for reversible fastening by means of the contact elements on a substrate surface, wherein the cross-sectional width (p), in some cases the operative diameter, of the contact elements is smaller than, in some cases at most half as large as, the transverse distance (t), wherein the contact elements are arranged in a circular ring with a ring width (RB) and an outer circle diameter (AK), in some cases on a circle with the diameter (KD), and form a polygon with a height (H), wherein the transverse distance (t) is smaller than the transverse width (b) and wherein at least one pair of contact elements has a contact distance (k) from one another which is greater than the sum of the transverse width (b) of a surface conductor path and the transverse distance (t) of the conductor-free surface between adjacent surface conductor paths and which is smaller than the sum of twice the transverse width (b) of adjacent surface conductor paths and the transverse distance (t) of the conductor-free surface between adjacent surface conductor paths, and/or, in some cases and, wherein the following applies for the height H of the polygon: H≥(b+2×t), wherein the contact elements in some cases have a contact element length (n), such as a needle length, for penetrating the conductor paths.

Accordingly, a current collector according to the present disclosure for an electrical load for mounting on a support system with a plurality of longitudinal electrical conductor paths running parallel or substantially parallel to one another in each case at a transverse distance (t) with a transverse width (b) with alternating electrical potential is provided. The potential difference between adjacent conductor paths can in some cases be in the low voltage range. The current collector according to the present disclosure can in some cases be a contacting adapter for the electrical load. In some cases, the electrical load is adapted and arranged for operation in the low voltage range.

The current collector according to the present disclosure comprises at least three, in some other cases at least five and in some even other cases exactly five electrically conductive contact elements. According to another expedient embodiment, the contacting adapter can have exactly seven electrically conductive contact elements. The contact elements can be of the same type and/or uniform. Each contact element is adapted and arranged to be contactable with an electrical conductor path of the support system in order to implement an electrical connection from the conductor path to the current collector according to the present disclosure. The electrically conductive contact elements have a cross-sectional width, in some cases an operative diameter. In an expedient embodiment, the electrical contact elements can have a substantially circular cross-section, in which the circle diameter as operative diameter corresponds to the cross-sectional width. Other cross-sectional shapes of an electrically conductive contact element, for example triangular, quadrangular or polygonal, are conceivable, wherein a largest diagonal can generally define the cross-sectional width of the respective contact element cross-section. The contact elements form a polygon with a height. The height of a polygon is generally determined as the largest distance between a base edge of the polygon and a second polygon edge diametrically opposite thereto or a polygon tip diametrically opposite thereto.

It is provided according to the present disclosure that the contact elements have a contact element length for penetrating the conductor paths, such as a needle length. Additionally or alternatively, the contact elements can have a pointed end for penetrating into the support layer and/or for penetrating the conductor paths. The contact elements of the current collector according to the present disclosure are in some cases aligned parallel to one another, so that all contact elements of the current collector have the same penetration and/or penetration direction. The contact elements in some cases have substantially the same contact element length. The contact element lengths in some cases protrude on an in some cases planar outer surface of the current collector, in some other cases orthogonally to the outer surface.

According to an expedient embodiment, the contact elements are needle-shaped, in some cases with a conically shaped insertion end. The insertion end can alternatively be pyramid-shaped, for example. In some cases, at least one, at least two or all contact elements of a current collector according to the present disclosure can be needle-shaped. Alternatively or additionally, the contact elements can be pin-shaped, in some cases with a cylinder section or consisting of a cylinder section. The cylinder section has a in some cases constant cross-sectional shape, wherein the cross-sectional shape can be circular, elliptical, triangular, quadrangular or polygonal, for example, in some cases polygonal with equal edge lengths. In some cases, it can be provided that the contact elements are needle-shaped, with a round cylinder section and a conically shaped end. Alternatively, the contact elements can be obelisk-shaped, with a polygonal, for example quadrangular, cylinder section and a pyramid-shaped end.

In one embodiment of the current collector according to the present disclosure, the cross-sectional width, in some cases the operative diameter, of the contact elements is in the range of 0.25 to 1.5 mm, in some cases in the range of 0.5 mm to 1.0 mm. In some cases for the transmission of currents in the low voltage range, it has been shown that such cross-sectional widths exhibit good current conduction and heating properties.

Alternatively or additionally, the contact element length, in some cases the needle length, is in the range of 0.5 to 10 mm, in some other cases in the range of 1.0 to 5.0 mm. All contact elements of the current collector in some cases have substantially the same contact element length. The cross-sectional width is in some cases smaller than the contact element length. As a result, when the contact element is introduced into the support system, in some cases the surface conductor path, the mechanical adhesion of the contact element to the support system can be ensured without having to accept aesthetic impairment.

According to at least one embodiment of a current collector according to the present disclosure, the contact elements each have a circumferential contact surface which is adapted and arranged to provide an electrical connection of one of the contact elements to a conductor path penetrated by this contact element. All contact elements in some cases have a contact surface. The contact surfaces of the plurality of contact elements are in some cases provided in the same longitudinal extension region of the different contact elements. The contact surface is in some cases formed over the entire circumference on the respective contact element, in some other cases along a longitudinal extension region of at least 50%, in some cases at least 75% or at least 90%, of the contact element length. The contact surface comprises or consists of at least one electrically conductive material. In some cases, the conductive material is selected from the group comprising brass, chromium, nickel, silver, copper, and gold. The contact surface is in some cases gold-plated, for example galvanized with gold. In some cases, the contact surface has a surface layer comprising or consisting of gold with a layer thickness of less than 0.5 μm, in some cases less than 0.2 μm or less than 0.1 μm.

In a current collector according to the present disclosure according to at least one expedient embodiment, the contact elements are arranged in a circular ring having a ring width and an outer circle diameter. In some cases, the contact elements are arranged on a circle having a predetermined diameter. The outer circle diameter is in some cases not more than 6.5 cm, in some other cases not more than 5 cm. With the aid of the arrangement of the contact elements in the region of a circular ring, in some cases on a predetermined circle, a large distribution of the different contact elements can be implemented in a small space.

According to an expedient embodiment of the current collector according to the present disclosure, the ring width of the circular ring is in the range of 0.2×b to 1.5×b, in some cases in the range of 0.3×b to 1.2×b, wherein b represents the transverse width of the surface conductor paths. It can be expedient that the ring width is smaller than a transverse width b of the conductor paths, in some cases surface conductor paths, of the support system, wherein in some cases the ring width can be selected to be smaller than or equal to the transverse distance t between adjacent surface conductor paths. Alternatively or additionally, the circle diameter is in the range of 1.0×b to 3.0×b, in some cases in the range of 1.2×b to 2.5×b. In some cases, the circle diameter is at least as great as the sum of a transverse width b and a transverse distance t of the support system.

In at least one embodiment of the current collector according to the present disclosure, adjacent contact elements are substantially equidistant from one another, wherein in some cases the distance between adjacent contact elements (along the circumference of the circular ring and/or polygon) differs from one another by no more than ±10%, in some cases by no more than ±5%. In some cases, the polygon can be equilateral and the contact elements are located on the corner points of the polygon. The polygon is in some cases a triangle, pentagon or heptagon. It has been found that equilateral polygons with contact elements on all their corner points are highly suitable for a large spatial coverage with the current collector with at the same time the smallest possible current collector size. Furthermore, it has surprisingly been shown that with the arrangement of the different contact elements at polygon corner points, in some cases for a pentagon or a heptagon, the so-called “clean-through” problem can be solved, according to which an electrical transmission from the support system with the adjacent conductor paths to a load by a current collector according to the present disclosure with unfavorable orientation and/or arrangement of the current collector could be omitted if no contacting of at least two conductor paths with potential difference is ensured. It shall be clear that the contact elements forming the polygon are expediently arranged at the corners of the polygon. At least one or exactly one contact element can in some cases be arranged within the polygon, in some cases in the center point of the polygon, which is advantageous for example in the case of a triangle.

According to an expedient embodiment, the current collector according to the present disclosure comprises a rectifier circuit. The rectifier circuit is in some cases adapted and arranged to ensure the current supply of the load with a predetermined direct current, independently of which of the plurality of contact elements is in electrical contact connection with a surface conductor path of a first potential and which other of the plurality of contact elements is in electrical contact connection with a surface conductor path of a second potential.

In an expedient embodiment of a current collector according to the present disclosure, the rectifier circuit is adapted and arranged to transmit an electrical potential difference between exactly one or at least a first of the at least three electrically conductive contact elements and exactly one or at least a second of the at least three electrically conductive contact elements to a current output. It is conceivable that a current collector with more than one contact element is in connection with a first conductor path and with one or more second contact elements is in connection with a second conductor path of a different potential level.

According to a suitable embodiment of the current collector according to the present disclosure, the rectifier circuit is adapted and arranged to transmit an electrical potential difference from any pair of the at least three, in some cases at least five, in some other cases exactly five or exactly seven, electrically conductive contact elements to the current output. With the aid of such a rectifier circuit, the current collector can in some cases be adapted to always ensure a current supply of the load independently of the position and orientation of the current collector and the contact elements provided thereon with respect to the plurality of conductor paths of the support system.

According to an expedient embodiment of the current collector according to the present disclosure, which can be combined with the above, the current collector can comprise a plurality of diodes, in some cases semiconductor diodes, wherein in some cases a plurality of the plurality of diodes are arranged in a circular ring having a diode ring width and an outer diode circle diameter, in some cases on a diode circle having a predetermined diameter. The outer diode circle diameter is in some cases not more than 6.5 cm, in some other cases not more than 5 cm. As a result of the arrangement of the plurality of diodes in a diode circular ring, in some cases on a diode circle, the greatest possible spacing of the heat-generating diodes from one another can be implemented. As a result, the service life can be extended. Thermally induced impairments of the support system can also be prevented.

In some cases, in at least one embodiment of a current collector according to the present disclosure with a plurality of diodes, it is provided that the diodes, in some cases all diodes of the rectifier circuit or of the current collector, each have a forward voltage of not more than 1 V, in some cases not more than 0.75 V, in some other cases not more than 0.5 V. The diodes are in some cases rectifier diodes, such as Schottky diodes.

In an expedient embodiment of a current collector according to the present disclosure, the plurality of diodes comprises or consists of a first group of diodes in electrical contact with a first pole of the current output and a second group of diodes in electrical contact with a second pole of the current output. The rectifier circuit is in some cases configured such that the potential difference which is applied to the pair of contact elements by the current collector is mapped at the first and the second pole of the current output. It can be highly expedient that the first group of diodes is arranged in a first, in some cases semicircular, segment and that the second group of diodes is arranged in another, in some cases semicircular, segment on a diode support structure, such as a circuit board, wherein in some cases the current output is arranged between the first segment and the other, second segment. As a result of the diodes being subdivided into two groups, in some cases a cathode group and an anode group, and these two groups being arranged in different segments on the current collector, a highly efficient heat management can be implemented, so that, with the smallest possible structural size of the current collector, the heat arising at the diodes can be dissipated well from the current collector to the surroundings. As a result of the segmentation, it is possible in some cases to largely avoid a mutual heating of directly adjacent diodes.

A suitable embodiment of the current collector according to the present disclosure comprises at least one magnetic holding component for the fixation of the current collector on a magnetic or magnetizable holding layer of the support system. The magnetic holding component can be provided in some cases on an underside of the current collector, from which the electrical contact elements protrude.

In an expedient embodiment of the current collector according to the present disclosure, which can be combined with the others, the current collector for at least one electrical load comprises at least one magnetic holding component for the fixation of the current collector on a magnetic or magnetizable holding layer of the support system. In some cases, the current collector is equipped with a magnetic underside or rear side, which faces or can face the holding layer. With the aid of the magnetic holding component, the fastening of the current collector on the support system can be improved and in some cases a penetration of the surface conductor paths with the contacts of the current collector can be ensured.

According to a suitable embodiment of a current collector according to the present disclosure, which can be combined with the above, the current collector has at least two connection receptacles, such as connection terminals, which are adapted and arranged to each receive at least one electrical lead of an electrical load.

In a current collector according to the present disclosure according to another embodiment, which can be combined with the others, the current collector has at least two connection receptacles, such as connection terminals, which are adapted and arranged to each receive at least one electrical lead of an electrical load. For example, such a current collector can be provided in order to supply a conventional wall or ceiling lamp with electrical energy by connecting the electrical supply leads of the conventional lamp to the connection terminals or other connection receptacles, for example in the manner of a luster terminal.

The present disclosure also relates to a kit-of-parts which contains a current collector according to the present disclosure (as described above) and a support system which is equipped with a plurality of longitudinal electrical surface conductor paths running in each case at a transverse distance t from one another. The surface conductor paths have a transverse width b.

The kit-of-parts in some cases comprises at least one current collector for an electrical load, comprising at least two or three, in some cases at least five and in some other cases exactly five, electrically conductive contact elements, adapted and arranged to interact with two adjacent electrical surface conductor paths of the support system. In some cases, the contact elements of the current collector are matched to the surface conductor paths such that at least two of the contact elements of the same current collector can be brought into contact with different, in some cases adjacent, surface conductor paths. For this purpose, for example, the contact elements can be matched in terms of their size, shape and distance to the size, shape and distance of the surface conductor paths.

A support system can in some cases be formed as a flat and/or quasi-two-dimensional support layer. The support layer can have, for example, a longitudinal longitude extent and a transversal transverse extent, which are very much greater than a thickness of the support layer. In the case of a kit-of-parts, for example for a building wall surface functional system, the longitudinal longitude extent can correspond to the vertical direction, the transversal transverse extent can correspond to an in some cases primary horizontal direction and/or the thickness of the support system, in some cases of the support layer, can correspond to a depth direction or secondary horizontal direction. Alternatively, in the case of a kit-of-parts, for example for a building ceiling surface functional system, the longitudinal longitude extent can correspond to a first in some cases primary horizontal direction, the transversal transverse extent can correspond to a second in some cases primary horizontal direction and/or the thickness of the support system, in some cases of the support layer, can correspond to a vertical direction. The support layer can be formed, for example, as a web material or as a surface coating.

A surface conductor path can generally denote an electrically conductive path whose longitudinal main extent direction is substantially greater than its thickness, in some cases at least one hundred times greater, in some other cases at least one thousand times greater. Alternatively or additionally, a surface conductor path can generally denote an electrically conductive path which has, transversely to the main extent direction, a transverse width which is substantially smaller than its longitudinal main extent, in some cases at least 10 times smaller or at least one hundred times smaller, and which is substantially greater than the thickness of the surface conductor path, in some cases at least 10 times greater or at least one hundred times greater. By way of example, a surface conductor path can have a longitudinal main extent of at least 1 m and a thickness of less than 0.5 mm, in some cases less than 0.1 mm, and in some other cases a transverse width in the range from 1 mm to 10 cm, in some cases in the range from 1 cm to 5 cm.

In an expedient embodiment, the surface conductor path can be embodied as a full-surface conductor path. Alternatively, it is conceivable that the surface conductor path is composed of a plurality of thin adjacent conductor path sections, which are in some cases at least in sections grille-shaped, checkerboard-pattern-like, grid-shaped, net-shaped and/or meandering, and which together, for example as a net, form the surface conductor path. The distance between such adjacent conductor path sections of a surface conductor path is always smaller than a contact point. In combination with the expedient embodiment described below, which cooperates with at least one current collector having a plurality of contact elements, the distance between such adjacent conductor path sections of a surface conductor path is always smaller than the largest cross-sectional width of the contact elements. In some cases, the cross-sectional width is in the range of 0.25 mm to 1.5 mm, in some other cases in the range of 0.4 mm to 1 mm, in some even other cases in the range of 0.5 mm to 0.8 mm.

At least one electrical surface conductor path, in some cases the plurality of electrical surface conductor paths, can be present on the front side on the support system, on the rear side on the support system, and/or embedded in the support system. It is conceivable that a first group of surface conductor paths is present on the front side on the support system, that a second group of surface conductor paths is present on the rear side on the support system, and/or that a third group of surface conductor paths is present embedded in the support system. In some cases, all of the plurality of electrical surface conductor paths can be present on the front side or rear side on the support system or embedded in the support system.

It is also of advantage in the case of the present disclosure that the mounting of the kit-of-parts according to the present disclosure does not necessarily require the use of electricians or of trained specialist personnel in the electrical field, but can also be carried out for example by personnel from the painting trade or dry construction.

In an expedient embodiment of the kit-of-parts, the contact elements have a cross-sectional width, in some cases an operative diameter, which is smaller than the transverse distance between adjacent surface conductor paths, in some cases corresponds substantially to half the transverse distance and/or is at least 0.5 mm, in some cases at least 1 mm, smaller than the transverse distance.

According to at least one embodiment of the kit-of-parts according to the present disclosure, the transverse distance of adjacent electrical surface conductor paths is smaller than the transverse width of these surface conductor paths. In some cases, the transverse width measures at least 45%, in some other cases at least 65% of the height of the polygon.

According to a further embodiment of the kit-of-parts according to the present disclosure, which can be combined with the above, at least one pair of contact elements of the same current collector has a contact distance to one another. It shall be clear that the pair of contact elements can consist of a first contact element connectable or connected to a first surface conductor path and a second contact element connectable or connected to a second surface conductor path. Furthermore, it shall be clear that the current collector can be equipped, for example, with a plurality of, for example three, contact elements which can be combined in a permutation-like manner as a plurality of pairs, for example three pairs. In another example of a current collector with five contact elements, the contact elements can be combined in a permutation-like manner in ten pairs, for example. The contact distance is in some cases greater than the sum of the transverse width of an electrical surface conductor path and the transverse distance of the conductor-free surface. In some cases, the contact distance is smaller than the sum of twice the transverse width of an electrical surface conductor path and the transverse distance of the conductor-free surface. In some cases, the following formula can apply to the height of the polygon, wherein H denotes the height of the polygon, b the transverse width of the conductor paths, and t the transverse distance between adjacent conductor paths: H≥(b+2×t).

The contact distance can in some cases correspond substantially to a transverse modulus defined as a sum of the transverse width of an electrical surface conductor path and twice the transverse distance of the conductor-free surface between electrical surface conductor paths, wherein in some cases the transverse modulus can be dimensioned to be slightly greater than the contact distance in order to ensure short-circuit-proof mountability of the current collector taking into account the cross-sectional size of the contact elements and/or in order to minimize the probability that no circuit is closed when connecting the current collector to the support system with the surface conductor paths. In some cases, substantially the same contact distance and transverse modulus can be assumed if contact distance differs from the transverse modulus by no more than ±20%, in some cases by no more than ±10%, in some other cases by no more than ±5%. It can be expedient that the contact distance is at least as large as the transverse modulus. In some cases, the contact distance is 0% to 20% greater, in some other cases 0.1% to 10% greater, in some even other cases 0.5% to 5% greater, compared to the transverse modulus.

It can be expedient that in a kit-of-parts according to the present disclosure the contact elements have a contact element length which is greater than a path thickness of the conductor paths and/or greater than a system thickness of the support system, wherein in some cases the contact element length is at least as large as the sum of path thickness and system thickness.

In an expedient embodiment of the kit-of-parts according to the present disclosure, which can be combined with the above, the plurality of surface conductor paths has a substantially uniform transverse width. In some cases, the plurality of surface conductor paths can also have substantially uniform transverse distances between adjacent surface conductor paths. Alternatively or additionally, the plurality of surface conductor paths has a substantially uniform longitudinal extent, which can in some cases correspond to a room height, length or width. Moreover, it can be expedient that the plurality of adjacent surface conductor paths extend in parallel or substantially in parallel. In some cases, a regular and/or uniform arrangement of the conductor paths can be determined by the support system.

In some cases, in a kit-of-parts according to the present disclosure, the plurality of adjacent surface conductor paths are in each case separated from one another by a conductor-free surface. According to an expedient embodiment, in some cases in the region of the support system, the plurality of adjacent surface conductor paths are in each case separated from one another, in some cases electrically insulated, by a conductor-free surface. In some cases, a plurality of surface conductor paths, in some cases all surface conductor paths, are electrically separated from one another, in some cases insulated, by a conductor-free surface in the region of the support system. In the case of adjacent surface conductor paths which adjoin one another and which accordingly have a transverse distance (t)=0, an electrically conductive contact between these conductor paths can be brought about e.g. by the provision of a thin electrically non-conductive layer or a thin electrically non-conductive film strip, which are in each case oriented substantially perpendicularly to the surface conductor paths and accordingly do not have a significant transverse extent, or a partial sheathing of the edges of adjacent surface conductor paths adjoining one another with an electrically non-conductive material, e.g. a plastics part sheathing, i.e. a plastics material sheathing only of the edge region. Those kit-of-parts according to the present disclosure are expedient in which the electrical insulation of adjacent surface conductor paths is brought about via conductor-free surfaces between these surface conductor paths. In these kit-of-parts according to the present disclosure, the transverse distance (t) is accordingly greater than zero.

Electrical connections between, in some cases adjacent, surface conductor paths can in some cases be closed by electronic components arranged transversely to the surface conductor paths, for example a current collector. The support system is in some cases free of electrical transverse connections between surface conductor paths arranged next to one another, in some cases adjacent. In some cases, by outsourcing an electrical connection of different surface conductor paths into additional components, such as the contact strip, a functional object and/or a current collector, it can be achieved that the consequences in the event of damage or incorrect assembly of the surface fusion system can be limited to a small range without impairing the general functionality of the entire support system.

In an expedient embodiment of the kit-of-parts according to the present disclosure, it is provided that the adjacent surface conductor paths of the plurality of adjacent surface conductor paths have substantially the same lateral distance (transverse distance) from one another and/or that the conductor-free surfaces between adjacent surface conductors of the plurality of adjacent surface conductors have substantially a uniform width. It can be expedient that the support system, which in the range of a transverse width of at least 20 cm, in some cases at least 50 cm, in some other cases at least 75 cm, in some even other cases over the complete transverse width of the support system, transversely, in some cases orthogonally, to the longitudinal direction, comprises at least one longitudinal electrical surface conductor path per 10 cm transverse width, in some cases per 5 cm transverse width, in some other cases per 3 cm transverse width, of the support system.

According to a likewise expedient embodiment of the kit-of-parts according to the present disclosure, which can be combined with the above, the transverse distance is in the range of at least 1 mm to 10 mm, in some cases 2 mm to 5 mm, in some other cases about 3 mm. Alternatively or additionally, the transverse width is in the range of at least 1 mm to 50 mm, in some cases 15 mm to 35 mm, in some other cases about 25 mm. The transverse distance of adjacent electrical surface conductor paths can be in the range of 2.0 to 20 mm, in some cases in the range of 4.0 to 10 mm.

In an expedient embodiment of a kit-of-parts according to the present disclosure with conductor-free surfaces, the conductor-free surface in each case defines a transverse distance between two adjacent surface conductor paths. In some cases, the conductor-free surfaces between in each case adjacent surface conductor paths of the plurality of surface conductor paths have an identical width. The surface conductor paths in each case have a transverse width between two adjacent conductor-free surfaces. The transverse width is at least as large as the transverse distance, in some cases for at least 5, in some other cases at least 10, in some even other cases more than 10 or all surface conductor paths of the support system of the kit-of-parts. In some cases, the transverse width is greater than the transverse distance, in some cases for at least 5, in some other cases at least 10, in some even other cases more than 10 or all surface conductor paths. Additionally or alternatively, the transverse modulus can be defined as the sum of the transverse width of an electrical surface conductor path and twice a transverse distance of the conductor-free surface, in some cases adjacent thereto. In the case of a kit-of-parts, the transverse width of the electrical surface conductor paths is in some cases in the range of 15 to 50 mm, in some other cases in the range of 20 to 40 mm.

According to an expedient embodiment, the electrical surface conductor paths represent low-voltage surface conductor paths.

In an expedient embodiment of the kit-of-parts according to the present disclosure, which can be combined with the above, the support system is magnetizable. It can be expedient that the support system is equipped with magnetizable materials, in some cases ferri- and/or ferromagnetic materials, e.g. magnetite. Alternatively or additionally, it can be provided that the kit-of-parts according to an embodiment further comprises at least one magnetizable holding layer, which is present on the front or rear side, in some cases on the front side, on the support system. These embodiments can in some cases be combined with other embodiments described above or below, in which the current collector and/or a functional object is configured to be magnetically or magnetizable. A kit-of-parts with a magnetic or magnetizable holding layer and/or magnetic or magnetizable support system has on the one hand the advantage that for example in rental homes objects can be mounted on a building surface, such as a building wall or ceiling, without damage by means of magnetic adhesion. An advantage of this embodiment of the kit-of-parts according to the present disclosure can be seen in the fact that with the aid of a magnetic force a secure mechanical contacting between the conductor paths and the current collector can be supported. Electrical functional objects can also have electrical contacts which, supported by a magnetic force pairing between the support system and the functional object, can provide a secure mechanical. According to an expedient embodiment of the kit-of-parts according to the present disclosure, the magnetizable holding layer comprises ferri- and/or ferromagnetic materials, which in some cases contain magnetite or consist of magnetite.

According to an expedient embodiment, the magnetizable or magnetic holding layer can comprise or represent a plaster coating, a filler layer, a paint layer, a primer layer, a plastic film or a non-woven layer, in some cases based on non-woven plastic, cellulose or glass fibers, which is equipped in each case with magnetizable materials, in some cases ferri- and/or ferromagnetic materials, e.g. magnetite.

The magnetizable holding layer or the magnetizable support layer can contain particulate magnetizable materials, in some cases ferri- and/or ferromagnetic materials. Among these particulate magnetizable materials, ferrites, in some cases magnetite, iron powder, in some cases ferromagnetic iron powder and/or carbon-containing iron powder, and any mixtures thereof are highly expedient. Among the stated particulate magnetizable materials, magnetite is expediently used. Such particulate magnetizable materials have proven to be highly suitable for achieving the object on which the present disclosure is based, which have an average particle size D50 in the range from 10 to 100 μm, in some cases in the range from 20 to 30 μm. The average particle size D50 can be determined according to DIN ISO 9276-1:2004-09 (representation of the results of particle size analyses—part 1: graphical representation) and ISO 9276-2:2014-05 (representation of the results of particle size analyses—part 2: calculation of average particle sizes/diameters and moments from particle size distributions). For the determination of the D50 values, so-called laser scattering particle size distribution analyzer, as available from the company Horiba under the device designation “LA 950 V2”, can be used.

According to an expedient embodiment of a kit-of-parts according to the present disclosure, the support system comprises a plasterboard, a plaster coating, a filler layer, a paint layer, a primer layer, a wooden board, a plastic film and/or a non-woven layer, in some cases based on non-woven plastic, cellulose or glass fibers. In some cases, the support system represents a plasterboard, a plaster coating, a filler layer, a paint layer, a primer layer, a wooden board, a plastic film and/or a non-woven layer, in some cases based on non-woven plastic, cellulose or glass fibers. The support system is in some cases path-shaped and flexible and/or can be rolled up or unrolled. For example, the support system can comprise or represent a wallpaper. In the case of a path-shaped support system, it can be expedient that the longitudinal direction of the electrically conductive conductor bands corresponds to the path direction of the support system, in some cases is parallel to the path direction, or that the longitudinal direction of the electrically conductive conductor bands is aligned transversely, in some cases orthogonally, to the path direction of the support system.

According to one embodiment, the at least one electrical surface conductor path, in some cases the plurality of, in some cases longitudinal, electrical surface conductor paths are selected from the group consisting of metallic surface conductors, in some cases of copper and/or aluminum foil, paths of electrically conductive ink applied in some cases by means of printing methods, conductive polymer compounds, and carbon fiber-based systems.

In an expedient embodiment of a kit-of-parts according to the present disclosure, this further comprises at least one active functional object, which is equipped with a magnetically active rear side. The active functional object can be or comprise, for example, a wall clock, a screen, a decorative fireplace, a base strip, a lamp, a home automation switch, a loudspeaker, a radio, an active noise cancelling system, a heating element, a smoke alarm, GPS tracker, liquid dispenser, such as a soap dispenser or disinfectant dispenser, and/or a sensor, such as a room sensor, for example a temperature sensor, noise sensor, brightness sensor, movement sensor, hygrometer, person sensor, vibration sensor. The active functional object in some cases comprises exactly one or more current collectors having a plurality of contact elements, as described above. In some cases, the functional object can comprise at least one electrical load having a current collector. The at least one active functional object in some cases comprises at least one electrical load, which in some cases can be supplied or is supplied with current in the low voltage range by the support system. A current supply in the low voltage range generally denotes a current supply significantly below the mains voltage of 230 V. In some cases, the current supply in the low voltage range is a current supply in the range of 48 V or less, in some other cases 24 V or less, in some even other cases 12 V or less, in some even further cases 6 V or less.

The present disclosure also relates to the use of a current collector according to the present disclosure as described above and/or a kit-of-parts according to the present disclosure, in some cases in a building, in some other cases in a rental home.

It shall be clear that the systems and devices according to the present disclosure, which are shown below by way of example with reference to the figures and which can in some cases be adapted and arranged for carrying out a method according to the present disclosure, are only shown schematically and described by way of example in the present disclosure. Numerous variations with respect to the expedient embodiments shown by way of example are conceivable within the scope of the disclosure.

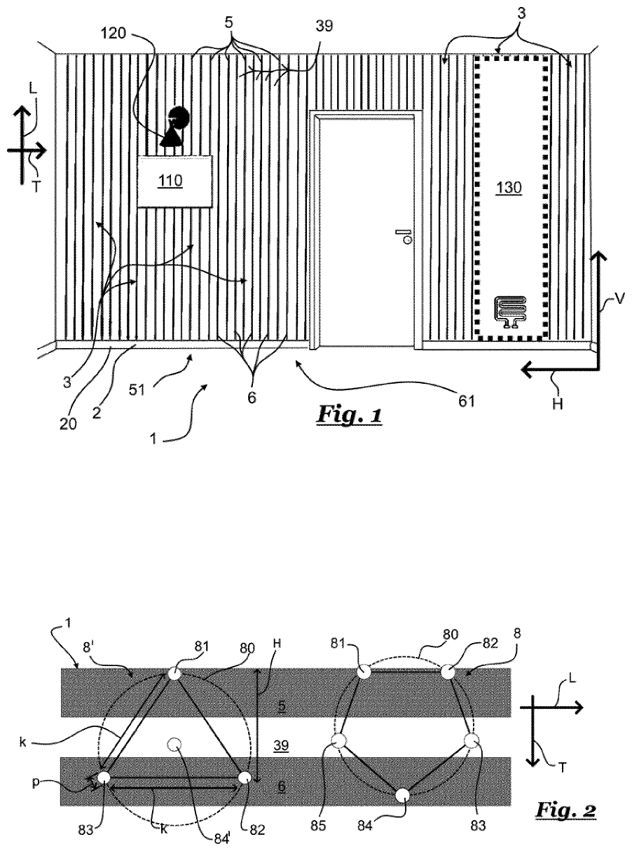

FIG. 1 schematically shows a kit-of-parts 1 according to the present disclosure, which is used as a building surface functional system. The kit-of-parts 1 in the depicted embodiment comprises a support system 3 with a plurality of longitudinal surface conductor paths 5, 6 and electrical loads 100 which are equipped with current collectors according to the present disclosure. The surface conductor paths 5, 6 in cooperation with the current collector 8, 8′ will be explained in more detail with reference to FIGS. 2 to 5. A current collector 8 is further described by way of example with reference to FIGS. 6 and 7.

The support system 3 can represent, for example, a plasterboard, a plaster coating, a filler layer, a paint layer, a primer layer, a plastic film and/or a non-woven layer, in some cases based on non-woven plastic, cellulose or glass fibers.

With the kit-of-parts 1, as depicted, a surface power supply in the low voltage range with 12 V, for example, can be provided on an inner wall of the room. With the aid of the surface functional system formed by the kit-of-parts, various active functional objects 100 are held on the wall and supplied with electrical energy in the low voltage range. An exemplary functional object 100 is the lamp 120. Another exemplary functional object 100 is the planar heating element 130. The surface functional system 1 supplies the lamp 120 and the heating element 130 with current in the low voltage range. The active functional objects 120, 130 comprise electrical loads and are equipped with one or more current collectors 8 (not illustrated in more detail in FIG. 1) for supplying these electrical loads.

The current collectors are adapted and arranged to form an electrical connection with the surface conductor paths 5, 6 in order to supply the active functional objects 120, 130 with electrical energy. The picture in the picture frame 110 can be provided with a passive illumination, which is supplied with current from two adjacent surface conductor paths by a current collector (not illustrated in detail).

For the surface power supply, the support system 3 of the kit-of-parts is equipped with the plurality of electrical conductor paths 5, 6, which extend in the longitudinal direction L. The transverse width b of the conductor paths 5, 6 in the transverse direction T transversely, in some cases orthogonally, to the longitudinal direction L is smaller by orders of magnitude than the longitudinal extent thereof. The conductor paths 5, 6 are strip-shaped. The thickness of the surface conductor paths 5, 6 is very much smaller than the longitudinal extent thereof and substantially smaller, in some cases smaller by orders of magnitude, than the transverse width b.

In the region of the support system 3, the conductor paths 5, 6 are not electrically connected to one another but rather electrically insulated from one another, in some cases by conductor-free regions 39. The conductor paths 5 and 6 can be divided into a first set of conductor paths 5 and a second set of conductor paths 6, in some cases on the basis of their electrical properties and/or spatial arrangement. The conductor paths of the first set of conductor paths 5 and those of the second set of conductor paths 6 are arranged alternately on or in the support system 3.

The conductor paths 5 and 6 depicted here have connecting ends 51 and 61 arranged next to one another. In the case of the embodiment illustrated in FIG. 1, all connecting ends 51, 61 are located at the lower longitudinal end of the support system 3 in the vertical direction V (here corresponding to the longitudinal direction L). The connecting ends 51, 61 are arranged in the region of the contact strip 2, which is formed here as a covering strip, namely as a foot strip. In alternative embodiments (not depicted), the contact strip could be formed as a cover strip or as a strip which extends transversely along the support system in the transverse direction L. The covering strip can in some cases be part of the kit-of-parts 1. Conductor bands for supplying current to the conductor paths 5, 6 are provided concealed in the interior of the contact strips 2. A first conduction band is electrically connected to the connecting ends 51 of the first set of electrical conductor paths 5. A second conduction band is electrically connected to the connecting ends 61 of the second set of electrical conductor paths 6. The first conduction band 25 can be connected to a first pole of a direct current source and the second conduction band to the second pole of this direct current source, wherein a potential difference in the low voltage range prevails between the direct current sources (not depicted in detail).

The functional objects 100 are equipped here with a magnetically active rear side 104. The support system 3 comprises a magnetizable or magnetic holding layer 34. The holding layer 34 cooperates with the magnetically active rear side 104 of the functional objects 100 in order to hold them reversibly in a locally fixed position on the wall.

The contact strip 2 can be formed in the manner of a profile, for example extruded. For shortening or cutting to length the contact strip, the contact strip 2 can be provided at regular intervals with notches or other predetermined breaking zones.

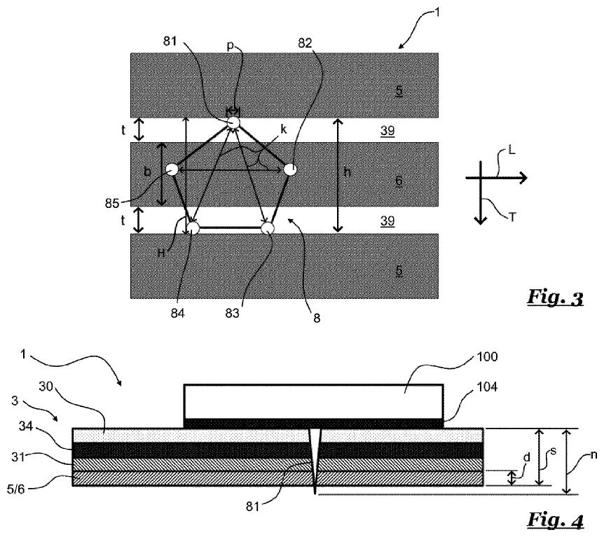

FIGS. 2 and 3 show different current collectors 8, 8′, which cooperate with the surface conductor paths 5 and 6 of the first and second set. The current collector 8′ illustrated on the left in FIG. 2 comprises four electrical contact elements 81, 82, 83 and 84′. Three of the contact elements 81, 82 and 83 are arranged in pairs at the same contact distance k relative to one another and span an isosceles triangle. These contact elements 81, 82, 83 are located on a circumference 80. The fourth electrical contact element 84′ is arranged in the center of the triangle, in some cases at the center point thereof. The contact elements 81, 82, 83 and 84′ have the same needle-shaped shape and cross-sectional width p. A first contact element 81 forms an electrical connection with a first surface conductor path 5. A second and a third contact element 82, 83 form an electrical contact with the second surface conductor path 6. The fourth contact element 84′ is located in the conductor-free region 39 between the adjacent conductor paths 5 and 6.

The current collector 8′ comprises a contacting adapter which is not illustrated in any more detail with a rectifier circuit which is not illustrated in any more detail, which is configured such that an electrical load can always be supplied with electrical energy by the current collector 8′, irrespective of which of the various contact elements 81, 82, 83, 84′ is or are in contact with the first or second surface conductor path 5 or 6, as long as only any pair of contact elements is in contact on the one hand with a conductor path 5 of the first set of conductor paths and on the other hand with a conductor path 6 of the second set of conductor paths, such that a potential difference is applied to the contact element pair (here: 81-83 or 81-82).

The other current collector 8 illustrated in FIG. 2 comprises five contact elements 81, 82, 83, 84 and 85 arranged at equal intervals on a circumference 80. The contact elements 81, 82, 83, 84 and 85 form the corner points of an isosceles pentagon. With the exception of the shape, substantially the same applies to this current collector 8 as to the current collector 8 described above. In the case of the current collector 8 too, contact element pairs (here: 81-84 or 82-84) are in electrically conductive connection on the one hand with a conductor path 5 of the first set and on the other hand with a conductor path 6 of the second set. In the depicted example, two contact elements 83, 85 are located in the conductor-free region 39.

The different surface conductor paths 5, 6 have a uniform transverse width b in the depicted embodiments. The conductor-free regions define a transverse distance t between the adjacent surface conductor paths 5, 6. The adjacent surface conductor paths 5 and 6 are oriented parallel to one another.

In the case of the kit-of-parts 1 illustrated in FIG. 3, a highly expedient relation of the dimensions of the surface conductor paths 5, 6 in relation to the current collector 8 is implemented. The current collector 8 in turn has an isosceles pentagon configuration of the contact elements 81, 82, 83, 84, 85. A conductor path-free region 39 is provided in each case between adjacent surface conductor paths 5 and 6. All surface conductor paths 5, 6 have substantially the same transverse width b and the same transverse distance t from the in each case adjacent surface conductor path 6 or 5. The transverse distance t between two adjacent surface conductor paths 5 and 6 is smaller than the transverse width b, in some cases smaller than half the transverse width 5, in some other cases smaller than a quarter of the transverse width and/or greater than a twentieth, in some cases greater than a tenth. The cross-sectional width p of the contact elements is the same size and, in some cases 1 mm, smaller than the transverse distance t.

Opposite contact elements 81, 82, 83, 84, 85 can be considered in pairs, wherein the pairs are in each case spaced apart from one another by a contact distance k. In the case of the depicted isosceles pentagon, the contact distances k of all pairs are of the same size. Other configurations are conceivable. The contact distance k of the current collector 8 is greater than the sum of a transverse width b and a transverse distance t, in some cases greater than a transverse modulus h, wherein the transverse modulus h corresponds to the sum of two transverse distances t and a transverse width b. The contact distance k of the current collector 8 is smaller than the sum of two transverse widths b and a transverse distance t.

The contact elements 81, 82, 83, 84, 85 of the current collectors 8 illustrated in FIGS. 2 and 3 (with the exception of the central contact element 84′) are arranged at the corner points or tips of a respectively isosceles polygon. Each polygon has a height H which can be determined in a manner known to a person skilled in the art as the distance from a base side edge of the polygon to an opposite tip or side edge of the polygon lying furthest apart. The height H of the polygon is in some cases at least as great as, in some other cases greater than, the transverse modulus h, so that contact elements distant from one another can enter into an electrical connection with different conductor paths 5, 6.

The above explanations with reference to a current collector 8 with pentagonally arranged contact elements 81, 82, 83, 84, 85 apply correspondingly to other polygon configurations.

Surprisingly, it has been shown that a contacting probability of at least 95%, in some cases at least 99%, can already be implemented with contact elements having a relatively small contact element circle circumference 80. A simple and secure use is ensured by the high contacting probability. For surface conductor paths 5, 6 having a transverse width b of approximately 25 mm and a transverse distance t of approximately 3 mm, it was surprisingly possible to establish the following values for an optimum circumcircle diameter of small diameter with the highest contacting probability:

| current collector | circumcircle diameter |
|---|---|
| equilateral triangle with | 4.1 cm |
| center contact | |
| equilateral pentagon | 3.4 cm |
| equilateral heptagon | 3.2 cm |

It has further been shown that the ratio of transverse width b to the sum of transverse width b and transverse distance t can be modified, wherein a high contacting probability can be maintained even with reduced surface coverage with surface conductor paths 5, 6, in some cases with an increased circumcircle diameter 80 to in some other cases not more than 6 cm, in some even other cases not more than 5.5 cm. For example, the surface coverage can be reduced by increasing the transverse distance to at least 5 mm, in some cases at least 6 mm, in some other cases at least 7.5 mm, in some even other cases at least 16.5 mm. Alternatively or additionally, the surface coverage can be reduced by reducing the transverse width. Deviating from the expedient surface coverage of about 89%, a reduced surface coverage of no more than 80%, in some cases no more than 76%, in some other cases no more than 60% can be provided. The surface coverage is in some cases at least 75% for a current collector 8′ with contact elements in the form of an equilateral triangle with center contact. The surface coverage is in some cases at least 70% for a current collector 8 with contact elements in the form of an equilateral pentagon. The surface coverage is in some cases at least 55% for a current collector with contact elements in the form of an equilateral heptagon.

FIG. 4 shows an exemplary cross-sectional view of a kit-of-parts 1 according to the present disclosure. In this kit-of-parts 1, the surface conductor paths 5 and 6 are provided on the rear surface of the support layer 31 of the support system 3. The support system 3 can be formed, for example, as a path material, for example as a non-woven layer, in some cases based on non-woven plastic, cellulose or glass fibers. The support layer 31 can alternatively or additionally be implemented as a plastic film.

Other configurations of the support layer 31 and/or the support system 3 are conceivable; for example, the surface conductor paths 5 and 6 could be arranged on different sides of the support layer or on the front side of the support layer 31. Alternatively, it is conceivable that the support system 3 is implemented, for example, as a plaster coating, filler layer or the like and the surface conductor paths 5 and 6 are present embedded in the support system 3 (not depicted). The support layer 31 can implement a magnetic or magnetizable holding layer in functional union.

In the expedient embodiment according to the present disclosure according to FIG. 4, a magnetizable holding layer 34 is provided on the support layer 31. A decorative coating 30 is provided on the front side of the support system 3. The support system 3 cooperates with a functional object 100. The functional object has a plurality of needle-shaped contact elements 81 (only one depicted) which are adapted and arranged to penetrate into the support system 3 and to be brought or to be brought into contact with the surface conductor path 5/6. The needle-shaped contact elements 81 are in some cases embodied to penetrate at least the surface conductor path 5 or 6, in some other cases the support system 3 completely. The surface conductor paths 5 and 6 have a path thickness d. The path thickness d is in some cases less than 1 mm, in some other cases less than 0.1 mm. The needle length or generally contact element length n of the contact element 81 is greater than the path thickness d. The support system 3 has a system thickness s. The needle length n is in some cases at least as great as the system thickness s.

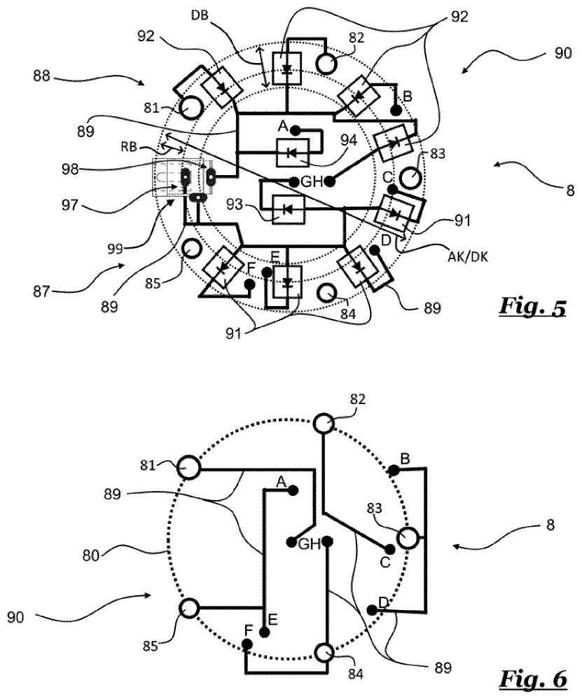

FIGS. 5 and 6 show schematic representations of an electrode support, in some cases a diode support structure, such as a circuit board. FIG. 5 shows the schematic plan view and FIG. 5 the schematic view from below of the same electrode support. The letters A, B, C, D, E, F, G and H in FIGS. 5 and 6 represent plated-through holes from the upper side to the underside, wherein it shall be clear that the same capital letter stands for the same plated-through hole. On the underside of the electron support, wide conductor paths 89 are provided, which electrically connect the contact electrodes 81, 82, 83, 84 and 85 to the plated-through holes. The wide conductor paths 89 on the electrode support are adapted and arranged for currents in the range from 0.1 A to 10 A, in some cases for currents in the range from 0.5 A to 5 A, in some other cases for currents in the range from 1 A to 3 A, in some even other cases for currents of approximately 2 A.

On the upper side of the electron support, the plated-through holes are connected by wide conductor paths 89 to a plurality of diodes 91, 92, 93, 94, which form the rectifier circuit 90, which operates the current output 99. The current output 99 can for example be implemented as a contacting adapter in order to receive two supply leads for an electrical load 100. The supply leads can be connected to two poles 97, 98 with different potential levels.

The current collector 8 depicted in FIGS. 5 and 6 has five electrical contact elements 81, 82, 83, 84, 85. The contact elements 81, 82, 83, 84, 85 are connected to ten diodes 91, 92, 93, 94. Eight diodes 91, 92 of these ten diodes are arranged on a diode circle, which here substantially corresponds to the circle 80 on which the contact elements 81, 82, 83, 84, 85 are arranged. An outer circle AK can be defined on the outer circumference of the electrode support, from which outer circle a ring width RB extends radially inwards in order to define a circular ring in which all contact elements 81, 82, 83, 84, 85 are arranged. In the exemplary embodiment shown here, a diode outer circle having the diode circle diameter DK is provided, which here corresponds to the outer circle diameter AK. Starting from the outer circle diameter AK, a diode ring width DB expands radially inwards, which defines, with the diode circle diameter, a diode circular ring in which most diodes 91, 92 of the plurality of diodes are arranged. Only two diodes 93, 94 are fastened to the electrode support within the diode circular ring.

The substantially circular electrode support of the current collector 8 can be divided into two semicircular segments 87, 88. The current output 99 is arranged in the central region between the segments 87 and 88. The first (the lower in the figure) circular segment 87 contains one half of the diodes 91, 93. The diodes 91, 93 in the first circular segment 87 are connected to the first pole 97 of the current output 89. The second (the upper in the figure) circular segment 88 contains the other half of the diodes 92, 94. The diodes in the second segment are electrically connected to the second pole 98 of the current output 89.

It is clear that the systems and devices according to the present disclosure, which are shown below by way of example with reference to the figures and which can in some cases be adapted and arranged for carrying out a method according to the present disclosure, are only shown schematically and described by way of example in the present disclosure. Numerous variations with respect to the expedient embodiments shown by way of example are conceivable within the scope of the disclosure.

The features of the present disclosure disclosed in the above description, the drawings and the claims can be essential both individually and in any combination for the realization of the present disclosure in its different embodiments.

### REFERENCE LIST

1 Kit-of-parts
2 electrical contact strip
3 support system
5 surface conductor path
6 surface conductor path
8, 8′ current collector
30 cover layer
31 support layer
34 holding layer
51 connecting end
61 connecting end
80 circle
81 contact element
82 contact element
83 contact element
84 contact element
84′ contact element
85 contact element
87, 88 segment
90 rectifier circuit
91, 92, 93, 94 diode
97, 98 pole
99 current output
100 functional object
104 magnetically active rear side
110 picture frame
120 lamp
130 heating element
b transverse width
d path thickness
h transverse modulus
k contact distance
n contact element length
p cross-sectional width
S system thickness
t transverse distance
H horizontal direction
L longitudinal direction
T transverse direction
V vertical direction
AK circle diameter
RB ring width
DK diode circle diameter
DB diode ring width

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A current collector for an electrical load for mounting on a support system, the support system including a plurality of longitudinal electrical conductor paths running parallel to one another with alternating electrical potential, the current collector comprising:
at least three electrically conductive contact elements with a cross-sectional width, wherein the electrically conductive contact elements form a polygon with a height, and
wherein the electrically conductive contact elements have a contact element length for penetrating the longitudinal electrical conductor paths.

2. The current collector according to claim 1, wherein
the electrically conductive contact elements are needle-shaped and/or pin-shaped.

3. The current collector according to claim 1, wherein:
the cross-sectional width of the electrically conductive contact elements is in a range of 0.25 to 1.5 mm.

4. The current collector according to claim 1, wherein:
the contact element length is in a range of 0.5 to 10 mm.

5. The current collector according to claim 1, wherein:
the electrically conductive contact elements each have a circumferential contact surface which is adapted and arranged to provide an electrical connection of one of the electrically conductive contact elements to a longitudinal electrical conductor path penetrated by the electrically conductive contact element, wherein the circumferential contact surface comprises or consists of at least one electrically conductive material, or
the electrically conductive contact elements are arranged in a circular ring having a ring width and an outer circle diameter.

6. (canceled)

7. The current collector according to claim 5, wherein:
the ring width of the circular ring is in a range of 0.2×b to 1.5×b, and/or
the outer circle diameter is in a range of 1.0×b to 3.0×b,
wherein b represents a transverse width of each longitudinal electrical conductor path of the plurality of longitudinal electrical conductor paths.

8. (canceled)

9. The current collector according to any claim 1, wherein:
the polygon is equilateral and the electrically conductive contact elements are located on corner points of the polygon.

10. The current collector according to claim 1, further comprising:
a rectifier circuit.

11-12. (canceled)

13. The current collector according to claim 10, wherein:
the current collector comprises a plurality of diodes, or
the current collector comprises a plurality of diodes each having a forward voltage of not more than 1 V.

14-16. (canceled)

17. The current collector according to claim 1, further comprising:
at least one magnetic holding component for fixation of the current collector on a magnetic or magnetizable holding layer of the support system from which the electrically conductive contact elements protrude, or
wherein the current collector has at least two connection receptacles which are adapted and arranged to each receive at least one electrical lead of an electrical load.

18. (canceled)

19. A kit-of-parts, containing:
i) at least one current collector according to claim 1; and
ii) a support system which is equipped with a plurality of longitudinal electrical surface conductor paths running in each case at a transverse distance from one another, each electrical surface conductor path having a transverse width,
wherein the electrically conductive contact elements of the at least one current collector have a cross-sectional width which is smaller than the transverse distance between adjacent electrical surface conductor paths.

20. (canceled)

21. The kit-of-parts according to claim 19, wherein:
the transverse distance between adjacent electrical surface conductor paths is smaller than the transverse width of the electrical surface conductor paths, or
the plurality of longitudinal electrical surface conductor paths each have a uniform transverse width, or
the plurality of longitudinal electrical surface conductor paths has a substantially uniform longitudinal extent, or
the plurality of adjacent electrical surface conductor paths are in each case separated from one another by a conductor-free surface.

22. The kit-of-parts according to claim 19, wherein:
at least one pair of contact elements has a contact distance to one another which is greater than a sum of the transverse width of an electrical surface conductor path and the transverse distance of a conductor-free surface between adjacent electrical surface conductor paths and which is smaller than a sum of twice the transverse width of adjacent surface conductor paths and the transverse distance of the conductor-free surface between adjacent surface conductor paths, and/or
for the height H of the polygon and the transverse distance t between adjacent electrical surface conductor paths: H≥(b+2×t), and/or
a transverse modulus is defined as a sum of the transverse width of an electrical surface conductor path and twice the transverse distance of the conductor-free surface between adjacent electrical surface conductor paths, wherein the contact distance substantially corresponds to the transverse modulus.

23. The kit-of-parts according to claim 19, wherein:
the contact elements have a contact element length which is greater than a path thickness of the conductor bands and/or greater than a system thickness of the support system.

24-25. (canceled)

26. The kit-of-parts according to claim 19, wherein:
the plurality of adjacent surface conductor paths extends in parallel.

27. (canceled)

28. The kit-of-parts according to claim 19, wherein:
in each case adjacent electrical surface conductor paths of the plurality of longitudinal electrical surface conductor paths have the same transverse distance from one another, and/or
the transverse width is in a range of at least 1 mm to 50 mm.

29. (canceled)

30. The kit-of-parts according to claim 19, wherein:
the transverse distance between adjacent electrical surface conductor paths is in a range of 2.0 to 20 mm and/or
the transverse width of the electrical surface conductor paths is in a range of 15 to 50 mm.

31. The kit-of-parts according to claim 19, wherein:
the electrical surface conductor paths are low-voltage surface conductor paths.

32. The kit-of-parts according to claim 19, wherein:
the support system is configured to be magnetizable.

33. The kit-of-parts according to claim 19, wherein:
the plurality of electrical surface conductor paths is selected from the group consisting of metallic surface conductors and paths of electrically conductive ink.

34-35. (canceled)
